(19) United States
(12) Patent Application Publication
(10) Pub. No.: US 2007/0230536 A1
(43) Pub. Date: Oct. 4, 2007

(54) Method and apparatus for detection of flaws in a metal component

(75) Inventors: Guenter Zenzinger, Petershausen (DE); Joachim Bamberg, Dachau (DE)

Correspondence Address: CROWELL & MORING LLP;INTELLECTUAL PROPERTY GROUP, P.O. BOX 14300, WASHINGTON, DC, 20044-4300, US

(73) Assignee: MTU Aero Engines GmbH, Munich (DE)

(21) Appl. No.: 11/390,676

(22) Filed: Mar. 28, 2006

(51) Int. Cl. G01N 25/72

(52) U.S. Cl. 374/4

(57) ABSTRACT

A method and apparatus for the detection of flaws, in particular of fissures, in metal components, is disclosed. A pulsed high-frequency magnetic field is coupled to the component. The temperature distribution of thermal energy generated by eddy currents during the application of a magnetic field pulse is detected.

### BACKGROUND AND SUMMARY OF THE INVENTION

The invention relates to a method and apparatus for the detection of flaws in metal components.

The non-destructive detection of flaws, in particular open and hidden fissures in components, is gaining increasing importance. The reason for this is that materials and components are increasingly designed to their stress limit. As a result, the requirements of quality control and of the flaw detection capability of non-destructive testing methods have become more stringent.

For over 40 years now, the non-destructive detection of open and hidden fissures in metal components by eddy current testing has been well established. In contrast with thermographic testing, which only responds in a sensitive manner to horizontal flaws (e.g., delaminations), vertical fissures can be sensitively detected by eddy current testing. In eddy current testing, an exploring coil is moved over the component. In so doing, measured signals are recorded dot by dot. Therefore, in order to test an area, the component must be scanned in individual test tracks. To achieve this, mechanical scanners have been developed for plane or circular components. For example, referring to German Patent Document No. DE 196 42 981 A1, a method and a device for scanning a component surface with the use of an eddy current probe have been known.

U.S. Pat. No. 5,430,376 relates to a method and a device for a combined layer thickness measurement and fissure testing on surface-coated metal components, such as, e.g., turbine blades. In so doing, it is necessary to completely sweep, i.e., scan, the surface of the component with a thermoelectric probe and with an eddy current probe.

CAD-generated components and parts, however, are increasingly characterized by more complex geometric configurations. These frequently strongly curved component surfaces, however, cannot be tested with such scanners or they can only be tested with reduced sensitivity. Considering components having a more complex geometric configuration, gapless testing requires considerable effort. The testing time is long. In addition, the component's corners and edges are not accessible with this testing method.

Referring to U.S. Pat. No. 5,562,345, a method for the analysis of fissures in components, whereby the component is heated by eddy currents and the temperature change is measured as a function of time, has been known. By comparison with data of a perfect component, conclusions can be drawn regarding flaws in the component. However, this method can be successfully used only on composite materials, which impair thermal conduction due to delamination. This method is not suitable for components that consist entirely of metal.

Referring to International Publication No. WO 99/10731, it has been known to locate and identify objects, such as mines or waste, buried in the ground, in that guided microwave energy is directed into the ground, the object in question is thus heated, and a local temperature difference on the ground surface above the object is detected by measuring technology means, preferably by means of an infrared camera. In so doing, advantage is taken of the fact that the heating behavior of the object in the microwave field is different from that of the surrounding earth.

German Patent Document No. DE 197 47 784 A1 discusses the detection of objects by means of thermosignature analysis in a relatively general and comprehensive manner. In so doing, energy is introduced into the object by means of an alternating electromagnetic field, then converted into thermal energy by exciting the substance-specific dipolar momentum, and detected as a thermosignature of the object's surface, e.g., by means of infrared sensors.

German Patent Document No. DE 199 33 446 C1 discloses a method for the detection of flaws in metal components, whereby a pulsed high-frequency magnetic field is coupled into the component, and the temperature distribution of thermal energy generated by the eddy currents is detected following a magnetic field pulse, i.e., before the heat conduction compensates for detectable temperature differences caused by flaws in the component.

Considering this, the object of the present invention is to provide a novel method for the detection of flaws in metal components.

In accordance with the invention, the temperature distribution due to heat generated by eddy currents when a magnetic field pulse is applied is detected.

As a result of the inventive detection of heat generated by eddy currents when a magnetic field pulse is applied, the detection of flaws can be optimized.

Preferably, the temperature distribution of the heating caused by the eddy currents during the application of a magnetic field pulse, and directly following the magnetic field pulse, is detected, i.e., before the heat conduction compensates for detectable temperature differences caused by flaws in the component.

A pulsed high-frequency magnetic field is applied to the area of the metal component that is to be tested, thus inducing eddy currents. Due to the electric resistance in the component, these currents generate thermal energy. The temperature of the component rises.

Inasmuch as the rise in temperature caused by heat conduction during the application of a magnetic field, as well as initially during the onset of eddy currents, is negligible, the rise in temperature is directly proportional to the introduced eddy current strength. If there is a flaw, in particular an open or hidden fissure, in the component, no eddy currents can form at this location. Consequently, no direct temperature increase occurs there. By detecting the temperature (thermal) image of the component during and preferably directly following a magnetic field pulse, flaws can be detected and visualized.

Inasmuch as the rise in temperature due to heat conduction is negligible during the initial time following the onset of eddy currents, a high-frequency magnetic field pulse duration between 0.1 sec and 1 sec has been found to be advantageous.

Preferably, the high-frequency magnetic field is generated by a coreless coil connected to a high-frequency generator. The region of the component to be tested is inserted in the coil. A strong alternating magnetic field is generated, the field penetrating the component surface to be tested and inducing eddy currents inside the component.

Favorable testing parameters have been found to be high-frequency generator frequencies of from 50 to 200 kHz, in particular, 100 kHz. In order to achieve significant heating of the component to be tested, a high-frequency generator power of from 0.5 to 2 kW, in particular 1 kW, is effective.

Preferably, in order to detect heating of the component to be tested, a thermographic camera, specifically an infrared camera, is used.

The method in accordance with the invention has the advantage that the entire area of the component to be tested can be tested in one operation. The component need not be scanned step by step. Consequently, short component testing times are the result.

### BRIEF DESCRIPTION OF THE DRAWING

Preferred developments of the invention are provided in the following description. One embodiment of the invention, without restricting the invention thereto, is explained in detail with reference to the drawing.

FIG. 1 is an inventive testing device which contains a component that is to be tested.

### DETAILED DESCRIPTION OF THE DRAWING

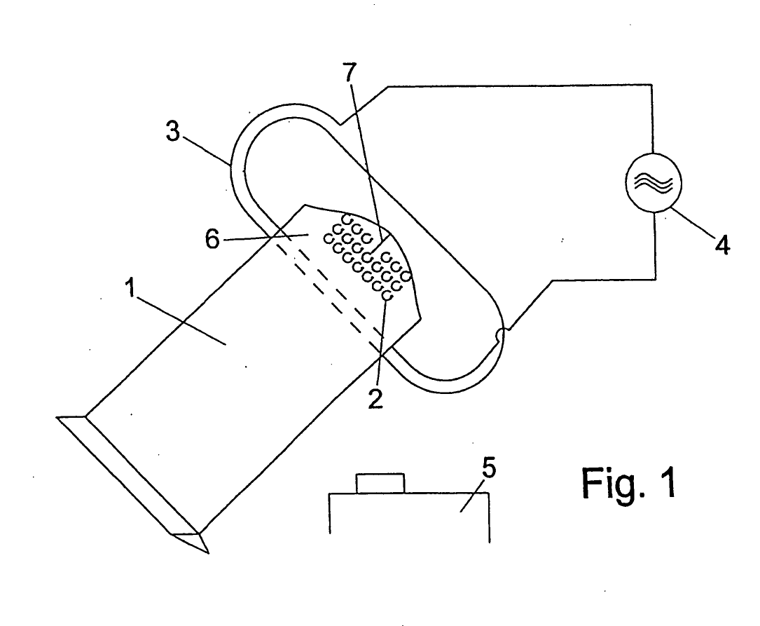

FIG. 1 shows a schematic representation of a turbine blade 1 having a curved blade pan tip 6 that is to be tested for fissures 7. To do so, the area 6 to be tested is inserted into the interior space of a coreless coil 3, which is connected to a high-frequency generator 4.

The high-frequency generator 4 is pulse-operated at a power output of 1 kW and at a frequency of 100 kHz. The optimal pulse duration depends on the metal to be tested and typically ranges between 0.1 sec and 1 sec, or slightly above that.

Within the coreless coil 3, the high-frequency generator 4 generates a strong alternating magnetic field which penetrates the surface of the blade pan tip 6 of the turbine blade 1, inducing schematically indicated eddy currents 2 therein.

Due to the eddy currents 2, the blade pan tip 6 is heated. Within the pulse duration of the high-frequency generator 4, the thermal conduction effects are still negligible. The temperature increase is functionally related to the introduced eddy current strength. If there is a fissure 7 in the component, no eddy currents 2 are formed at this location, and, hence, there is no temperature increase either.

In accordance with the invention, the temperature distribution of thermal energy caused by eddy currents during the application of a magnetic field pulse, as well as preferably also directly following a magnetic field pulse, is detected. By using temperature (thermal) images, even vertical fissures 7 in the component can be sensitively detected. By detection of the temperature distribution, even during the application of a magnetic field pulse, the detection of flaws can be clearly optimized.

A temperature (thermal) image of the component to be tested is recorded by the thermographic camera 5, which preferably is configured as an infrared camera. To achieve this, the thermographic camera 5 provides a snapshot of the temperature distribution at a pre-specific time.

Testing of the entire component 1 or the area 6 of the component to be tested can take place in one operation. Complex scanning of the component is no longer necessary. Even corners and edges of a component having a complex geometric configuration are accessible.

List of Reference Numbers:

1 Component

2 Eddy currents

3 Coil

4 High-frequency generator

5 Thermographic camera

6 Area

7 Fissures

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for the detection of a flaw, in particular a fissure, in a metal component, wherein a pulsed high-frequency magnetic field is applied to the component and wherein a temperature distribution of thermal energy generated by eddy currents is detected during an application of a magnetic field pulse.

2. The method according to claim 1, wherein the temperature distribution of the thermal energy generated by the eddy currents is detected during the application of the magnetic field pulse and following the magnetic field pulse, before heat conduction compensates for a detectable temperature difference caused by the flaw in the component.

3. The method according to claim 1, wherein a pulse duration of the magnetic field pulse is between 0.1 second to 1 second.

4. The method according to claim 1, wherein to generate the high-frequency magnetic field, a coreless coil and a high-frequency generator are used.

5. The method according to claim 4, wherein the high-frequency generator is operated at a frequency of from 50 to 200 kHz

6. The method according to claim 5, wherein the high-frequency generator is operated at a frequency of 100 kHz.

7. The method according to claim 4, wherein the high-frequency generator is operated at a power of from 0.5 to 2 kW.

8. The method according to claim 7, wherein the high-frequency generator is operated at a power of 1 kW.

9. The method according to claim 1, wherein a thermographic camera detects the temperature distribution.

10. A method for detection of a flaw in a metal component, comprising the steps of:
inserting the component into an interior space of a coreless coil which is connected to a high frequency generator;
applying a magnetic field pulse generated by the generator to the component through the coreless coil;
creating eddy currents in the component by the magnetic field pulse; and
detecting a temperature distribution of thermal energy caused by the eddy currents during the application of the magnetic field pulse.

11. An apparatus for detection of a flaw in a metal component, comprising:
a high frequency generator;
a coreless coil connected to the high frequency generator, wherein the component is insertable into an interior space of the coreless coil and wherein a magnetic field pulse generated by the generator is applied to an inserted component through the coreless coil; and
a detector;
wherein the magnetic field pulse creates eddy currents in the inserted component and wherein the detector detects a temperature distribution of thermal energy caused by the eddy currents during the application of the magnetic field pulse.
